(19) United States
(12) Patent Application Publication
(10) Pub. No.: US 2016/0014483 A1
(43) Pub. Date: Jan. 14, 2016

(54) SHARING OF MOTION DATA BETWEEN DEVICE SUBSYSTEMS

(71) Applicant: Intel Corporation, Santa Clara, CA (US)

(72) Inventors: Saket S. Jha, Bangalore (IN); Chandru Aswani, Bangalore (IN); Tirosh Levin, Hadera (IL)

(73) Assignee: Intel Corporation, Santa Clara, CA (US)

(21) Appl. No.: 14/326,604

(22) Filed: Jul. 9, 2014

(51) Int. Cl. H04Q 9/00

(52) U.S. Cl. CPC H04Q 9/00

(57) ABSTRACT

Generally, this disclosure provides systems, devices, methods and computer readable media for sharing and coordination of motion data between subsystems of a mobile device. A device with motion data capabilities may include a plurality of sub-systems, at least one of the sub-systems may further include: a motion sensor to provide motion data associated with the device and a performance indicator module to provide performance quality data associated with the motion data. The device may further include a motion data interface to provide communication between the plurality of sub-systems such that a first of the sub-systems can selectively obtain motion data from a second of the sub-systems. The selection, by the first sub-system, may be based on the performance quality data associated with the second sub-system.

### FIELD

The present disclosure relates to motion data sharing and coordination, and more particularly, to motion data sharing and coordination between subsystems of a mobile device.

### BACKGROUND

The architecture of mobile communication and computing devices often includes multiple sub-systems, many of which generate data related to the motion of the device. These multiple sub-systems may generate motion data using different techniques with varying levels of accuracy, reliability and availability that may not consistently meet operational requirements and may impact network/wireless connectivity of the mobile device. Additionally, the independent and possibly redundant generation of motion information may increase power consumption and decrease operating efficiency of the device.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates a top level system diagram of one example embodiment consistent with the present disclosure;

FIG. 2 illustrates a block diagram of another example embodiment consistent with the present disclosure;

FIG. 3 illustrates a block diagram of another example embodiment consistent with the present disclosure;

FIG. 4 illustrates a data flow diagram of one example embodiment consistent with the present disclosure;

FIG. 5 illustrates a data flow diagram of another example embodiment consistent with the present disclosure;

FIG. 6 illustrates a flowchart of operations of one example embodiment consistent with the present disclosure; and

FIG. 7 illustrates a system diagram of a platform of another example embodiment consistent with the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure provides systems, devices, methods and computer readable media for sharing and coordination of motion data between subsystems of a mobile device. Motion sensors, associated with one or more of the device sub-systems, may be configured to generate the motion data. Performance quality data, associated with the motion data, may also be generated by, and shared between, sub-systems. The sub-systems may be configured to select and use motion data provided by another sub-system, based on the performance quality data associated with that motion data. For example, a first sub-system may seek to obtain motion data from a second sub-system which satisfies a performance quality requirement that the first sub-system may be unable to otherwise achieve.

A motion data interface may be configured to provide motion data communication capabilities between the sub-systems. The interface may include a software level interface (e.g., message formats and protocols) and/or a hardware level interface (e.g., physical signal lines). The interface may be configured to transfer motion data, sensor capabilities and performance quality information between sub-systems. The interface may also be configured to allow sub-systems to register for motion related events and to be alerted or signaled when such events occur.

The sharing of motion data between sub-systems may decrease power consumption and improve efficiency and connectivity of the device, as will be explained in greater detail below.

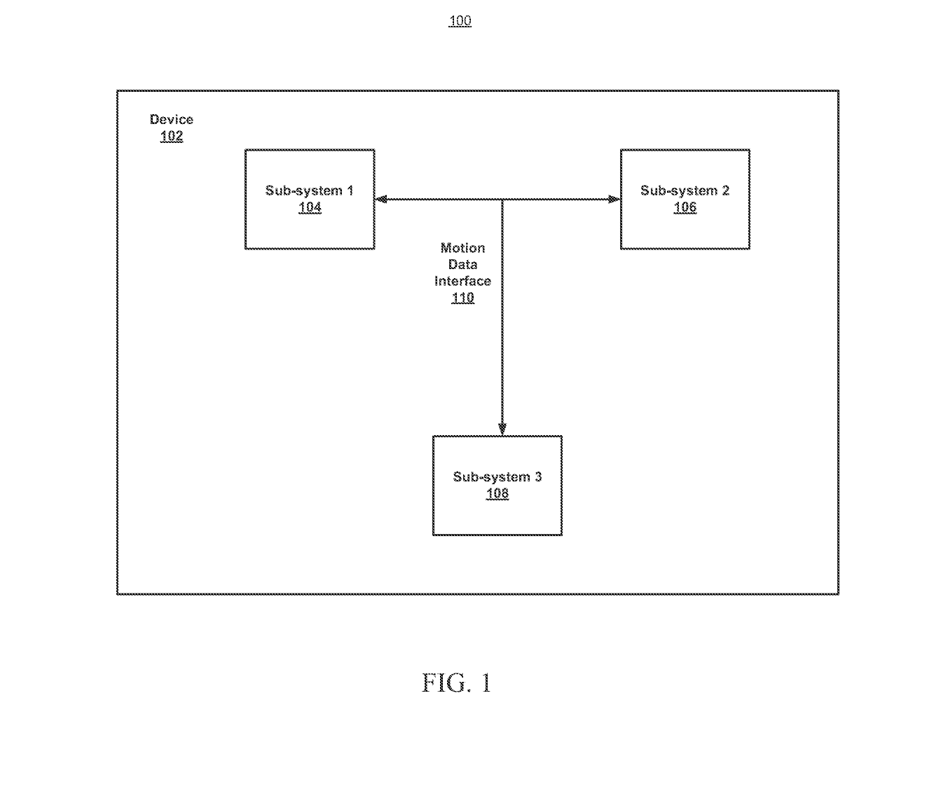

FIG. 1 illustrates a top level system diagram 100 of one example embodiment consistent with the present disclosure. A device 102 is shown to include a number of sub-systems 104, 106, 108. The device 102 may be, for example, a smart phone, smart tablet, personal digital assistant (PDA), mobile Internet device (MID), convertible tablet, notebook, laptop computer or any other type of mobile computing and/or communication device. Examples of sub-systems may include cellular communication modules, Wireless Fidelity (WiFi) communication modules, Bluetooth® modules, Near Field Communication (NFC) modules, Frequency Modulated High Definition Radio (FM/HDR) and/or Global Navigation Satellite System (GNSS) modules including those for Global Positioning System (GPS). Although only three sub-systems are illustrated for simplicity, it will be appreciated that embodiments of the device 102 may include any number of sub-systems.

One or more of the subsystems 104, 106, 108 may include sensors configured to generate, or otherwise obtain, data associated with motion of the device 102 (i.e., motion data) which may include speed and heading, as will be explained in greater detail below. The sub-systems 104, 106, 108 are shown to be coupled by a motion data interface 110, configured to provide motion-related communication and signaling capabilities between the sub-systems. The motion data interface 110 may be implemented as software, hardware or any combination thereof.

Motion information may be used in connection with many tasks that a mobile device may perform including, for example, navigation (both indoor and outdoor), maintaining cellular and wireless connectivity, generating augmented reality and determining GNSS positioning refresh rates.

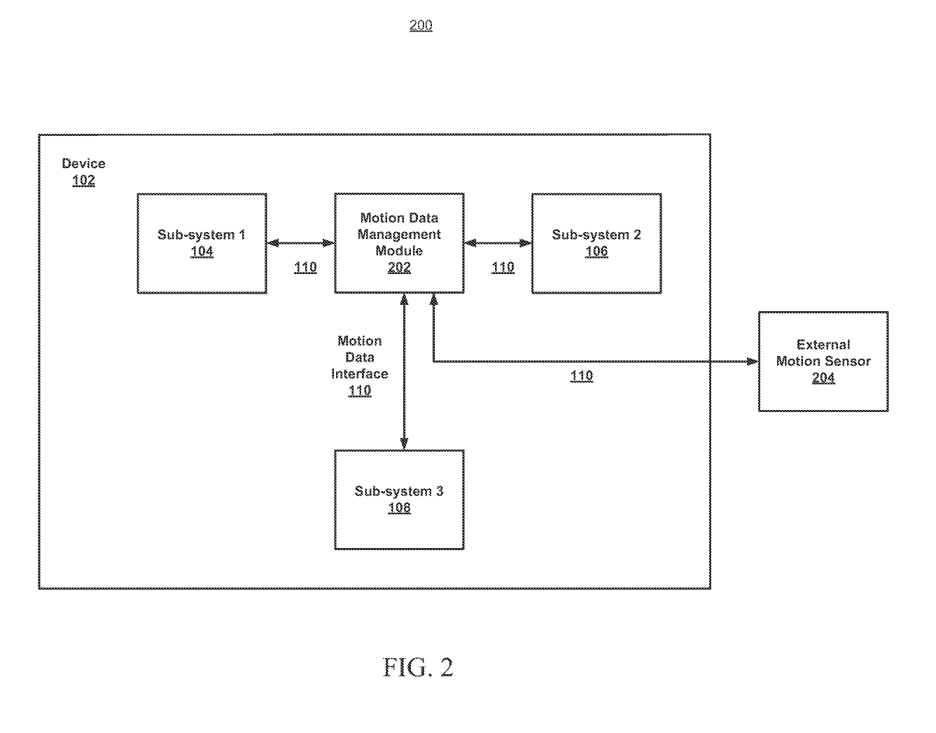

FIG. 2 illustrates a block diagram 200 of another example embodiment consistent with the present disclosure. In this embodiment, the device 102 is shown to further include a motion data management module 202, configured to facilitate the interface between sub-systems 104, 106, 108. The motion data management module 202 may be configured to maintain, for example in a database, information related to the status and capabilities of the sub-systems, at least with regard to motion data generation. Status and capabilities may include, for example, availability, accuracy, reliability and limitations of the motion data generated by a sub-system. The motion data management module 202 may query the various sub-systems, periodically or upon request, to obtain this information.

The motion data management module 202 may further be configured to route motion data requests and motion data replies between the sub-systems based, at least in part, on the status and capability information. Requests and replies may also include requests, by a sub-system, to register for motion-related events and subsequent signaling to notify the sub-system when the event occurs. Events may include, for example, occasions when the device speed or heading falls between a specified range of values. An event may thus include the case where the device becomes stationary (speed approximately zero) or when the device is headed in a specific direction, for example up.

In some embodiments, one or more external motion sensors (or motion reporting sources) 204 may be configured to provide additional motion data. Sensor 204 may be external to the device 102. For example, sensor 204 may be a camera configured to track the motion of objects (such as the device) within its field of view and estimate the speed and/or direction of those objects. The camera may further be configured to transmit that information wirelessly in a manner that the device can receive.

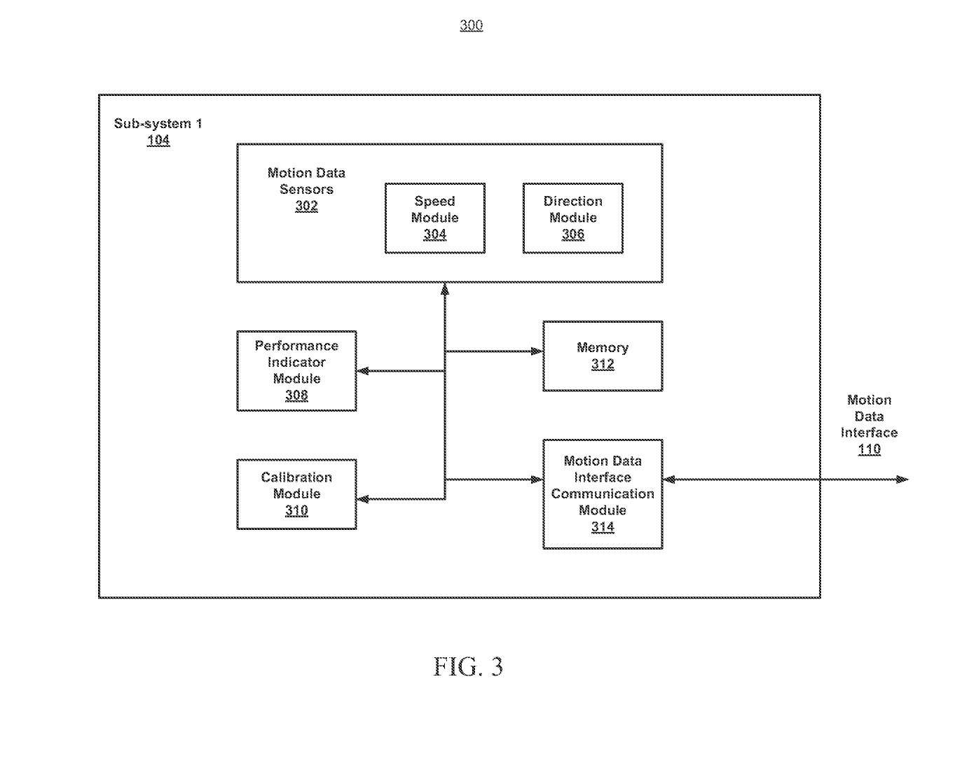

FIG. 3 illustrates a block diagram 300 of another example embodiment consistent with the present disclosure. A sub-system 104 is shown to include motion data sensors 302, performance indicator module 308, calibration module 310, memory 312 and motion data interface communication module 314. Motion data sensors 302 may further include a speed sensor module 304, a direction or heading sensor module 306 and/or any other suitable type of motion data sensor. The combination of speed and heading sensors may be configured to provide a 3-dimensional (3D) motion vector that indicates the motion of the device through 3D space at any instant in time for which the sensors may be sampled. The 3D motion vector may, of course, also indicate that the device is stationary or nearly stationary during a given period of time.

Performance indicator module 308 may be configured to provide performance quality data associated with the motion data. Performance quality data may include availability, accuracy, reliability, range limitations and/or any other indications or metrics that may be useful in determining the suitability or applicability of the motion data for an intended purpose. Range limitations may include, for example, the ability of the motion sensors to detect speeds limited to a particular range of values or headings limited to 2 dimension rather than 3 dimensions or heading limited to a particular range of angles, for example relative to some coordinate system.

Motion data and performance quality data may be stored in memory 312 until ready for communication over the motion data interface 110 or for any other purposes including tracking or historical reference.

Motion data interface communication module 314 may be configured to facilitate communication between the sub-system 104 and the motion data interface. For example, motion data and other information may be processed to conform to an expected format or protocol. Motion data interface communication module 314 may also be configured to monitor for signals associated with motion events for which the sub-system 104 has registered.

Calibration module 310 may be configured to calibrate the motion data sensors 302 based on motion data received from other sub-systems. This may be particularly useful under conditions where other sub-systems provide motion data with higher performance quality. Additionally, motion data obtained from multiple sources may be combined (for example through averaging, weighted averaging and other mathematical operations) to generate improved estimates of the device motion which may then be used for calibration and other purposes. Calibration may enable the quality of the motion data sensors to be maintained or improved over time.

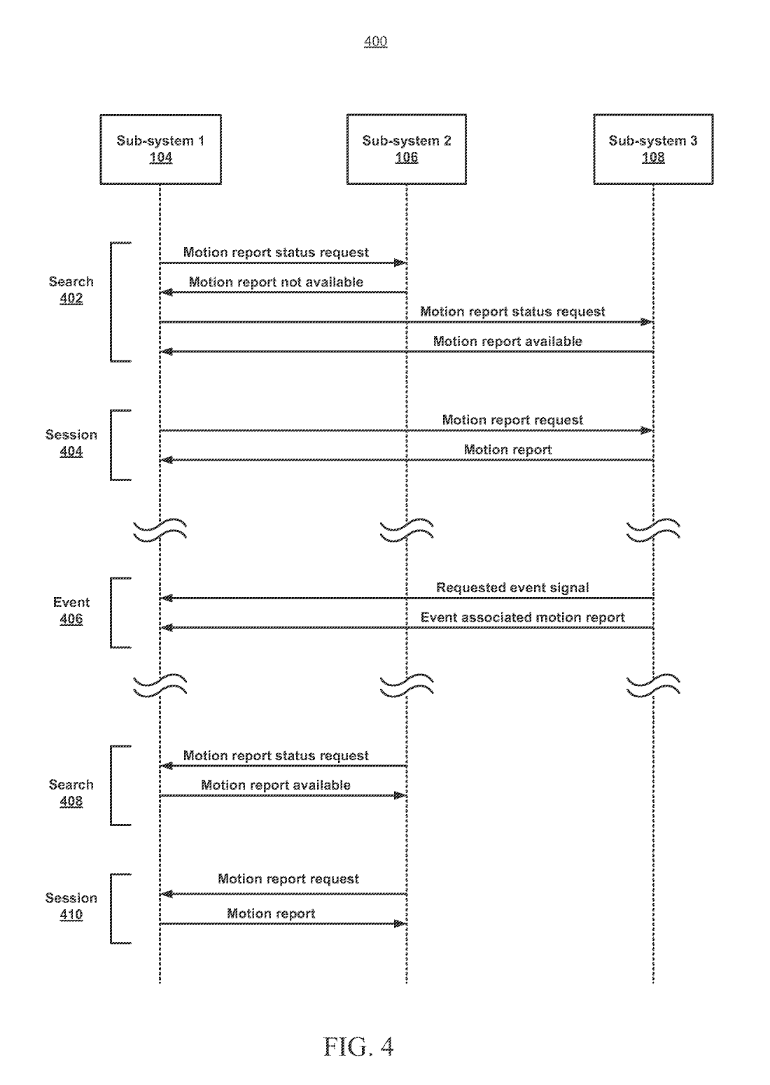

FIG. 4 illustrates a data flow diagram 400 of one example embodiment consistent with the present disclosure. Communication between sub-systems 104, 106 and 108 is shown consistent with the example embodiment illustrated in FIG. 1. The operations may begin with sub-system 104 performing a search 402 of the other sub-systems 106, 108. A motion report status request is made to sub-system 106 and a reply is received indicating that a motion report is not currently available. The term “motion report” is used to describe any collection of motion-related information that may be communicated or signaled between sub-systems. A motion report status request is next made to sub-system 108 and a reply is received indicating that a motion report is available. At this point a session 404 is established when sub-system 104 makes a motion report request to sub-system 108. Sub-system 108 responds by providing the motion report.

The motion report request of session 404 may also include a request by subsystem 104 to register for an event, such as, for example, that the device is stationary. If and when this event subsequently occurs 406, a requested event signal along with the event associated motion report are sent from sub-system 108, which is capable of detecting the event, to sub-system 104.

Sub-system 106 is shown to subsequently perform a search 408 beginning with sub-system 104. A motion report status request is made to sub-system 104 and a reply is received indicating that a motion report is available. The motion report may be available from sub-system 104, due to the recent transmission of motion information in session 404 and/or event 406, from sub-system 108. At this point, sub-system 106 may discontinue searching and initiate a session 410 with sub-system 104 by transmitting a motion report request and receiving the motion report.

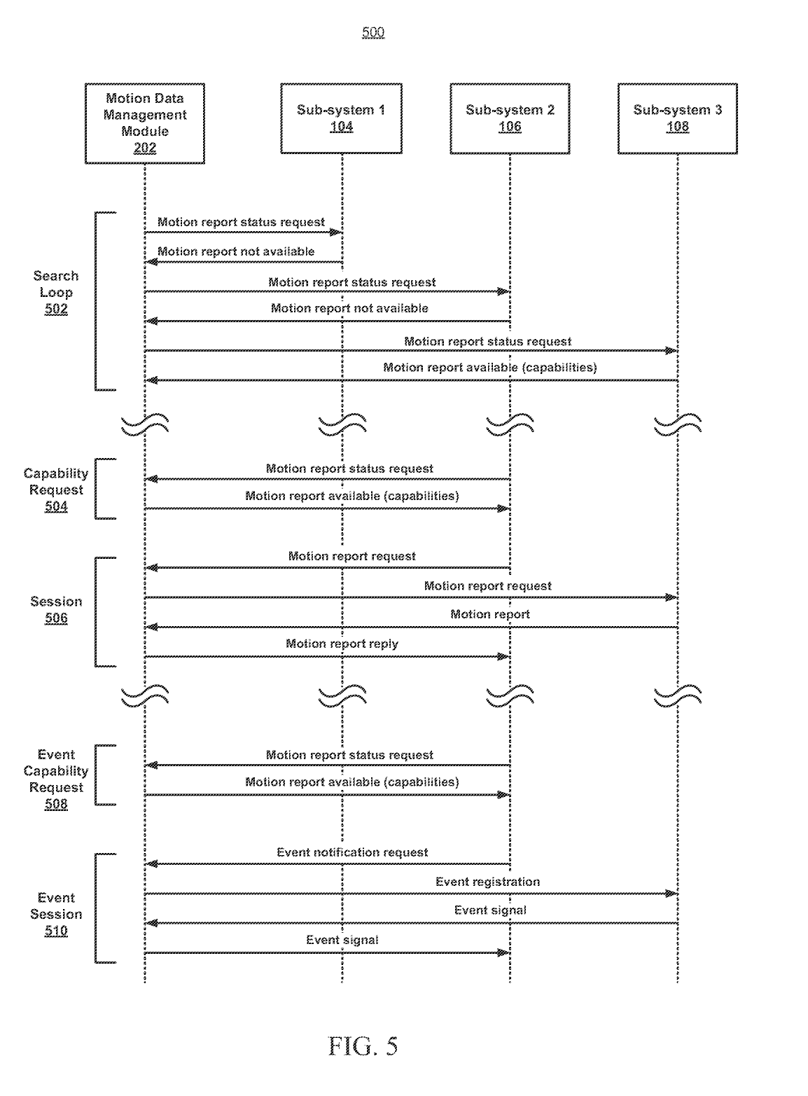

FIG. 5 illustrates a data flow diagram 500 of another example embodiment consistent with the present disclosure. Communication between motion data management module 202 and sub-systems 104, 106 and 108 is shown consistent with the example embodiment illustrated in FIG. 2. Motion data management module 202 may perform a searching loop 502 of the other sub-systems 104, 106, 108. As shown, a motion report status request is made to sub-systems 104 and 106 and replies are received indicating that a motion report is not currently available. The motion report status request made to sub-system 108, however, is successful and a reply is received indicating that a motion report is available. The reply may also include information about the motion-related capabilities of sub-system 108, such as, for example, the performance quality data.

A capability request 504 may be generated by, for example, sub-system 106, which includes a motion report status request to the motion data management module 202 and a motion report available reply. The reply may include information relating to the capabilities that may be provided by one or more of the other sub-systems, the capability information having been collected and maintained by the management module 202.

A session 506 may then be established when sub-system 106 makes a motion report request to management module 202, which the management module then forwards to sub-system 108 due to the fact that sub-system 108 capabilities meet the current requirements of sub-system 106. Sub-system 108 responds by providing the motion report to management module 202 which then forwards it to sub-system 106.

Also shown in FIG. 5, an event capability request 508 may be generated by, for example, sub-system 106, which includes a motion report status request to the motion data management module 202 and a motion report available reply. The reply may include information relating to the event signaling capabilities that may be provided by one or more of the other sub-systems.

An event session 510 may then be established when sub-system 106 makes an event notification request to management module 202 which then transmits an event registration to sub-system 108. If and when this event subsequently occurs, the requested event signal (along with event associated motion information) is sent from sub-system 108, which is capable of detecting the event, management module 202 which forwards this to sub-system 106.

The sharing and coordination of motion data between device sub-systems may allow for more efficient operation of the device and its sub-systems as well as improved power consumption. For example, if a GPS sub-system is active but other sub-systems are idle, the GPS may provide relatively accurate motion information to those other sub-systems. In contrast, if the GPS sub-system is in the process of acquiring satellites, one or more other sub-systems may provide motion information to assist the GPS with more rapid satellite acquisition.

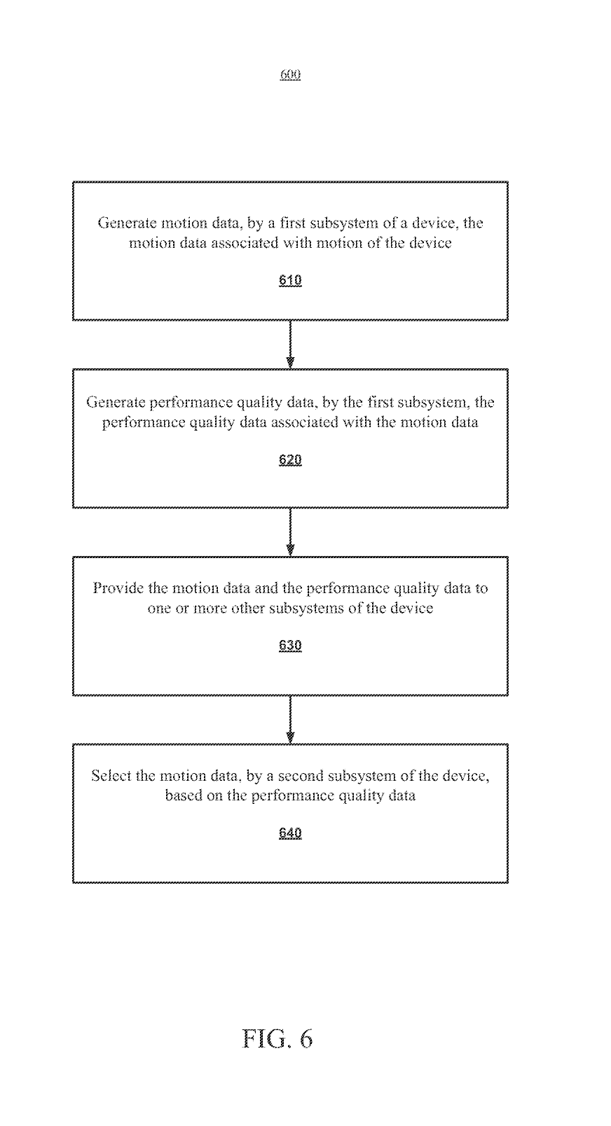

FIG. 6 illustrates a flowchart of operations 600 of another example embodiment consistent with the present disclosure. The operations provide a method for sharing motion data between subsystems of a device, for example a mobile device. At operation 610, motion data is generated by a first of the subsystems. The motion data is associated with motion of the device. At operation 620, performance quality data is generated by the first of the subsystems. The performance quality data is associated with the motion data. At operation 630, the motion data and the performance quality data is provided to one or more of the other subsystems. At operation 640, the motion data is selected, by a second of the subsystems, based on the performance quality data.

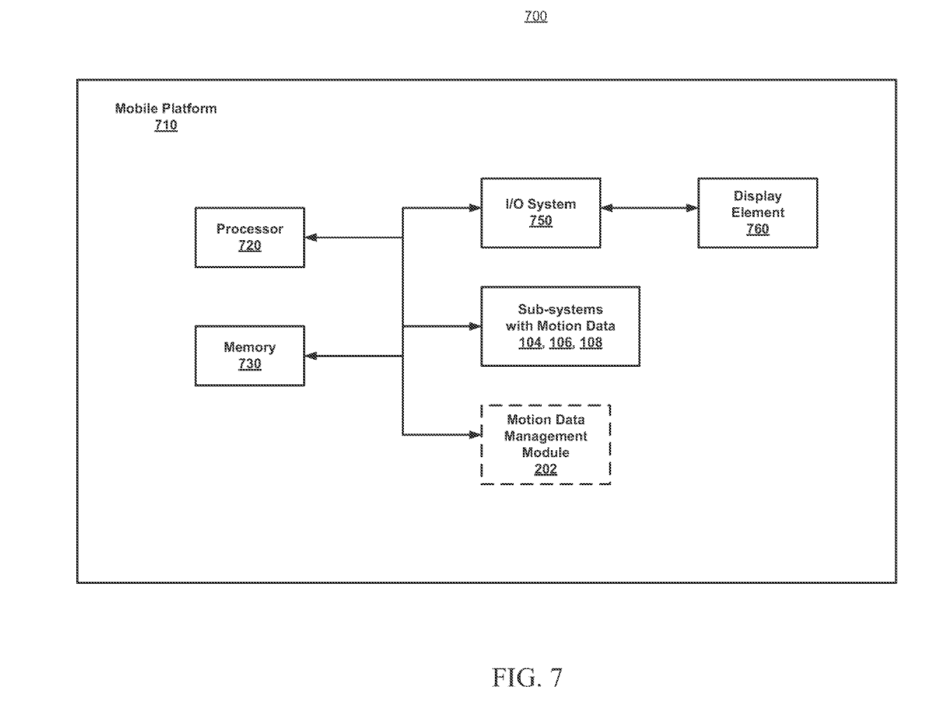

FIG. 7 illustrates a system diagram 700 of one example embodiment consistent with the present disclosure. The system 700 may be a mobile platform 710 or computing device such as, for example, a smart phone, smart tablet, personal digital assistant (PDA), mobile Internet device (MID), convertible tablet, notebook or laptop computer, or any other suitable device. The device may generally present various interfaces to a user via a display element 760 such as, for example, a touch screen, liquid crystal display (LCD) or any other suitable display type.

The system 700 is shown to include a processor 720. In some embodiments, processor 720 may be implemented as any number of processor cores. The processor (or processor cores) may be any type of processor, such as, for example, a micro-processor, an embedded processor, a digital signal processor (DSP), a network processor, a field programmable gate array or other device configured to execute code. Processor 720 may be a single-threaded core or, a multithreaded core in that it may include more than one hardware thread context (or “logical processor”) per core. System 700 is also shown to include a memory 730 coupled to the processor 720. The memory 730 may be any of a wide variety of memories (including various layers of memory hierarchy and/or memory caches) as are known or otherwise available to those of skill in the art. It will be appreciated that processor 720 and memory 730 may be configured to store, host and/or execute one or more user applications or other software modules. These applications may include, but not be limited to, for example, any type of computation, communication, data management, data storage and/or user interface task. In some embodiments, these applications may employ or interact with any other components of the mobile platform 710.

System 700 is also shown to include sub-systems 104, 106, 108, . . . with motion data generation and sharing capabilities, as described previously. System 700 may optionally include motion data management module 202 configured to facilitate motion data sharing between sub-systems as described previously. In some embodiments, sub-systems 104, 106, 108, . . . may include wireless communication capabilities, such as, for example, cellular communications, Wireless Fidelity (WiFi), Bluetooth®, Near Field Communication (NFC), Frequency Modulated High Definition Radio (FM/HDR) and/or Global Navigation Satellite System (GNSS) including Global Positioning System (GPS). The wireless communications may conform to or otherwise be compatible with any existing or yet to be developed communication standards including past, current and future version of Bluetooth®, Wi-Fi and mobile phone communication standards.

System 700 is also shown to include an input/output (IO) system or controller 750 which may be configured to enable or manage data communication between processor 720 and other elements of system 700 or other elements (not shown) external to system 700.

It will be appreciated that in some embodiments, the various components of the system 700 may be combined in a system-on-a-chip (SoC) architecture. In some embodiments, the components may be hardware components, firmware components, software components or any suitable combination of hardware, firmware or software.

Embodiments of the methods described herein may be implemented in a system that includes one or more storage mediums having stored thereon, individually or in combination, instructions that when executed by one or more processors perform the methods. Here, the processor may include, for example, a system CPU (e.g., core processor) and/or programmable circuitry. Thus, it is intended that operations according to the methods described herein may be distributed across a plurality of physical devices, such as processing structures at several different physical locations. Also, it is intended that the method operations may be performed individually or in a subcombination, as would be understood by one skilled in the art. Thus, not all of the operations of each of the flow charts need to be performed, and the present disclosure expressly intends that all subcombinations of such operations are enabled as would be understood by one of ordinary skill in the art.

The storage medium may include any type of tangible medium, for example, any type of disk including floppy disks, optical disks, compact disk read-only memories (CD-ROMs), compact disk rewritables (CD-RWs), digital versatile disks (DVDs) and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

“Circuitry”, as used in any embodiment herein, may include, for example, singly or in any combination, hardwired circuitry, programmable circuitry, state machine circuitry, and/or firmware that stores instructions executed by programmable circuitry. An app may be embodied as code or instructions which may be executed on programmable circuitry such as a host processor or other programmable circuitry. A module, as used in any embodiment herein, may be embodied as circuitry. The circuitry may be embodied as an integrated circuit, such as an integrated circuit chip.

Thus, the present disclosure provides systems, devices, methods and computer readable media for sharing and coordination of motion data between subsystems of a mobile device. The following examples pertain to further embodiments.

According to example 1 there is provided a device with motion data capabilities, the device may include a plurality of sub-systems. At least one of the sub-systems of this example may further include a motion sensor to provide motion data associated with the device; and a performance indicator module to provide performance quality data associated with the motion data. The device of this example may also include a motion data interface to provide communication between the plurality of sub-systems such that a first of the sub-systems can selectively obtain motion data from a second of the sub-systems, the selection based on the performance quality data associated with the second sub-system.

Example 2 may include the elements of the foregoing example, and further include a motion data management module to maintain a database of sub-system status and capabilities associated with at least one of the sub-systems; and further to route motion data requests and motion data replies between the plurality of sub-systems based, at least in part, on the database of sub-system status and capabilities.

Example 3 may include the elements of the foregoing example, and the motion data includes speed or heading of the device.

Example 4 may include the elements of the foregoing example, and the performance quality data includes motion data availability status, motion data accuracy indication, motion data reliability indication or motion data range limitations.

Example 5 may include the elements of the foregoing example, and the motion data interface is further to transmit motion events between the plurality of sub-systems.

Example 6 may include the elements of the foregoing example, and the motion events include device speed within a pre-determined range of values.

Example 7 may include the elements of the foregoing example, and the motion events include device heading within a pre-determined range of values.

Example 8 may include the elements of the foregoing example, and the subsystems are a cellular communications interface, a Wireless Fidelity (WiFi) interface, a Bluetooth® interface, a Near Field Communication (NFC) interface, a Frequency Modulated High Definition Radio (FM/HDR) or a Global Navigation Satellite System (GNSS) interface.

Example 9 may include the elements of the foregoing example, and the device is a smart phone, smart tablet, notebook or laptop computer.

According to example 10 there is provided a method for sharing motion data between subsystems of a device. The method may include generating motion data, by a first of the subsystems, the motion data associated with motion of the device. The method of this example may also include generating performance quality data, by the first of the subsystems, the performance quality data associated with the motion data. The method of this example may further include providing the motion data and the performance quality data to one or more of the subsystems. The method of this example may further include selecting the motion data, by a second of the subsystems, based on the performance quality data.

Example 11 may include the operations of the foregoing example, and further includes maintaining a database of sub-system status and capabilities associated with at least one of the sub-systems; and routing motion data requests and motion data replies between the sub-systems based, at least in part, on the database of sub-system status and capabilities.

Example 12 may include the operations of the foregoing example, and the motion data includes speed or heading of the device.

Example 13 may include the operations of the foregoing example, and the performance quality data includes motion data availability status, motion data accuracy indication, motion data reliability indication or motion data range limitations.

Example 14 may include the operations of the foregoing example, and further includes transmitting motion events between the sub-systems.

Example 15 may include the operations of the foregoing example, and the motion events include device speed within a pre-determined range of values.

Example 16 may include the operations of the foregoing example, and the motion events include device heading within a pre-determined range of values.

Example 17 may include the operations of the foregoing example, and the subsystems are a cellular communications interface, a Wireless Fidelity (WiFi) interface, a Bluetooth® interface, a Near Field Communication (NFC) interface, a Frequency Modulated High Definition Radio (FM/HDR) or a Global Navigation Satellite System (GNSS) interface.

According to example 18 there is provided a system for sharing motion data between subsystems of a device. The system may include means for generating motion data, by a first of the subsystems, the motion data associated with motion of the device. The system of this example may also include means for generating performance quality data, by the first of the subsystems, the performance quality data associated with the motion data. The system of this example may further include means for providing the motion data and the performance quality data to one or more of the subsystems. The system of this example may further include means for selecting the motion data, by a second of the subsystems, based on the performance quality data.

Example 18 may include the elements of the foregoing example, and further includes means for maintaining a database of sub-system status and capabilities associated with at least one of the sub-systems; and means for routing motion data requests and motion data replies between the sub-systems based, at least in part, on the database of sub-system status and capabilities.

Example 28 may include the elements of the foregoing example, and the motion data includes speed or heading of the device.

Example 28 may include the elements of the foregoing example, and the performance quality data includes motion data availability status, motion data accuracy indication, motion data reliability indication or motion data range limitations.

Example 28 may include the elements of the foregoing example, and further includes means for transmitting motion events between the sub-systems.

Example 28 may include the elements of the foregoing example, and the motion events include device speed within a pre-determined range of values.

Example 28 may include the elements of the foregoing example, and the motion events include device heading within a pre-determined range of values.

Example 28 may include the elements of the foregoing example, and the subsystems are a cellular communications interface, a Wireless Fidelity (WiFi) interface, a Bluetooth® interface, a Near Field Communication (NFC) interface, a Frequency Modulated High Definition Radio (FM/HDR) or a Global Navigation Satellite System (GNSS) interface.

According to another example there is provided at least one computer-readable storage medium having instructions stored thereon which when executed by a processor, cause the processor to perform the operations of the method as described in any of the examples above.

According to another example there is provided an apparatus including means to perform a method as described in any of the examples above.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. A device with motion data capabilities, said device comprising:
a plurality of sub-systems, at least one of said sub-systems comprising:
a motion sensor to provide motion data associated with said device; and
a performance indicator module to provide performance quality data associated with said motion data; and
a motion data interface to provide communication between said plurality of sub-systems such that a first of said sub-systems can selectively obtain motion data from a second of said sub-systems, said selection based on said performance quality data associated with said second sub-system.

2. The device of claim 1, further comprising a motion data management module to maintain a database of sub-system status and capabilities associated with at least one of said sub-systems; and further to route motion data requests and motion data replies between said plurality of sub-systems based, at least in part, on said database of sub-system status and capabilities.

3. The device of claim 1, wherein said motion data comprises speed or heading of said device.

4. The device of claim 1, wherein said performance quality data comprises motion data availability status, motion data accuracy indication, motion data reliability indication or motion data range limitations.

5. The device of claim 1, wherein said motion data interface is further to transmit motion events between said plurality of sub-systems.

6. The device of claim 5, wherein said motion events comprise device speed within a pre-determined range of values.

7. The device of claim 5, wherein said motion events comprise device heading within a pre-determined range of values.

8. The device of claim 1, wherein said subsystems are a cellular communications interface, a Wireless Fidelity (WiFi) interface, a Bluetooth® interface, a Near Field Communication (NFC) interface, a Frequency Modulated High Definition Radio (FM/HDR) or a Global Navigation Satellite System (GNSS) interface.

9. The device of claim 1, wherein said device is a smart phone, smart tablet, notebook or laptop computer.

10. A method for sharing motion data between subsystems of a device, said method comprising:
generating motion data, by a first of said subsystems, said motion data associated with motion of said device;
generating performance quality data, by said first of said subsystems, said performance quality data associated with said motion data;
providing said motion data and said performance quality data to one or more of said subsystems; and
selecting said motion data, by a second of said subsystems, based on said performance quality data.

11. The method of claim 10, further comprising:
maintaining a database of sub-system status and capabilities associated with at least one of said sub-systems; and
routing motion data requests and motion data replies between said sub-systems based, at least in part, on said database of sub-system status and capabilities.

12. The method of claim 10, wherein said motion data comprises speed or heading of said device.

13. The method of claim 10, wherein said performance quality data comprises motion data availability status, motion data accuracy indication, motion data reliability indication or motion data range limitations.

14. The method of claim 10, further comprising transmitting motion events between said sub-systems.

15. The method of claim 14, wherein said motion events comprise device speed within a pre-determined range of values.

16. The method of claim 14, wherein said motion events comprise device heading within a pre-determined range of values.

17. The method of claim 10, wherein said subsystems are a cellular communications interface, a Wireless Fidelity (WiFi) interface, a Bluetooth® interface, a Near Field Communication (NFC) interface, a Frequency Modulated High Definition Radio (FM/HDR) or a Global Navigation Satellite System (GNSS) interface.

18. At least one computer-readable storage medium having instructions stored thereon which when executed by a processor result in the following operations for sharing motion data between subsystems of a device, said operations comprising:
generating motion data by a first of said subsystems, said motion data associated with motion of said device;
generating performance quality data by said first of said subsystems, said performance quality data associated with said motion data;
providing said motion data and said performance quality data to one or more of said subsystems; and
selecting said motion data, by a second of said subsystems, based on said performance quality data.

19. The computer-readable storage medium of claim 18, further comprising the operations of:
maintaining a database of sub-system status and capabilities associated with at least one of said sub-systems; and
routing motion data requests and motion data replies between said sub-systems based, at least in part, on said database of sub-system status and capabilities.

20. The computer-readable storage medium of claim 18, wherein said motion data comprises speed or heading of said device.

21. The computer-readable storage medium of claim 18, wherein said performance quality data comprises motion data availability status, motion data accuracy indication, motion data reliability indication or motion data range limitations.

22. The computer-readable storage medium of claim 18, further comprising the operation of transmitting motion events between said sub-systems.

23. The computer-readable storage medium of claim 22, wherein said motion events comprise device speed within a pre-determined range of values.

24. The computer-readable storage medium of claim 22, wherein said motion events comprise device heading within a pre-determined range of values.
